(19) United States
(12) Patent Application Publication
(10) Pub. No.: US 2004/0109687 A1
(43) Pub. Date: Jun. 10, 2004

(54) Fast rerouting method through generalized multi-protocol label switching

(76) Inventors: Hyeon Park, Daejeon (KR); Sun Hee Yang, Daejeon (KR); Sang Ha Kim, Daejeon (KR); Wan Seop Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/704,398

(22) Filed: Nov. 6, 2003

(30) Foreign Application Priority Data
Dec. 10, 2002 (KR) 2002-0078460

(51) Int. Cl. H04J 14/00

(52) U.S. Cl. 398/57

(57) ABSTRACT

The present invention provides a fast rerouting method through Generalized Multi-Protocol Label Switching (GMPLS). The method performs fast rerouting through when a failure occurs on a link and node in an optical network having a plurality of nodes. In the fast rerouting method, current node of the optical network receives the path message for label request from a higher node thereof and establish the main LSP. Further, the current node calculates a detour path therefrom to a next but one node thereof so as to provide against a failure of the next node. Further, if it is checked that the Loss Of Light (LOL) occurs in the current node, the current node establishes the detour path to allow data to flow through the calculated detour path.

### BACKGROUND OF THE INVENTION

1. Field of the Invention

The present invention relates generally to a method of performing fast rerouting when the failure occurs on an optical link or path in an optical transport network, and more particularly to a fast rerouting method, which performs line restoration by locally repairing a failed link or path using generalized multi-protocol label switching signaling information, routing information, and link management protocol information in link restoration which is difficult to implement in a conventional multi-protocol label switching network.

2. Description of the Prior Art

Recently, in order to accommodate the exponential increase in Internet service networks due to the development of the Internet, an optical transport network based on a Wavelength Division Multiplexer (WDM) is gradually introduced into a carrier network. An example of providing Internet Protocol (IP) services by the WDM network, as described above, is published in a thesis entitled “IP over WDM Network Traffic Engineering Demonstration and Experimentation” by John Y. Weid et al., OFC' 2001 (pp. PD33-1).

WDM technology is characterized in that several hundreds of optical channels are multiplexed, so a single optical fiber can accommodate a very wide band. Actually, P-T-P WDM links for multiplexing several tens of optical channels are accommodated in a carrier network and executed, due to limitations in terms of extensibility and equipment costs of networks, like a Synchronous Optical Network (SONET) and a Synchronous Digital Hierarchy (SDH) network. A failure on an optical link or path in such an optical transport network causes much information loss, compared to a failure in an electrical transport network. Therefore, it is important for the optical transport network to be equipped with a fast optical restoration ability capable of coping with the performance of SONET ring architectures.

The optical restoration is classified into protection and restoration in a narrow sense. The protection is to perform dedicated backup path setup, pre-planed network resource reservation, etc. before a failure occurs. Further, the restoration in a narrow sense is to establish a backup path after a failure occurs. As technologies to solve the failure, there are two switching technologies, that is, path switching and line switching. Link restoration technology, which is one of the line switching technologies, calculates and establishes a new route between two nodes in which a failure occurs. In the link restoration technology, restoration time and resource efficiency must be considered. The present invention relates to a method of performing link restoration by locally repairing a failed link using Generalized Multi-Protocol Label Switching (GMPLS) signaling information, routing information, and Link Management Protocol (LMP) information.

In a conventional Multi-Protocol Label Switching (MPLS) network, fast rerouting is carried out such that no signaling is performed at a position where a link failure is sensed, and data traffics are detoured to a position adjacent to the position where the link failure occurs. In the fast rerouting procedure, a start point where restoration must be performed is a position where the failure is sensed, not a source node of a Label Switching Path (LSP). Accordingly, there is no need to propagate the failure to a restoration position using a signaling protocol. Most fast rerouting protection schemes are implemented such that they depend on pre-signaled backup resources, and programs in a corresponding node are simply revised when the failure is reported to the restoration point. According to the fast rerouting protection schemes, data flows through another label and port, not a previous label and port.

As described above, link protection is a simple form of the conventional fast rerouting. In the link protection, a LSP tunnel for backup is established and the LSP provides a parallel virtual link, such that data traffics are switched to the virtual link from a physical link if a failure occurs, thus minimizing data loss. As shown in FIG. 1, in such link protection, a tunnel Ta is established between a Label Switched Router (LSR) A 101 and a LSR B 102 to protect a link therebetween. If a failure occurs on a link between the LSR A 101 and the LSR B 102, a Label Switching Path (LSP) La is detoured to the tunnel Ta. At this time, the capacity of a backup LSP, that is, the tunnel Ta, must be guaranteed to be equivalent to the capacity of the original LSP La. Further, previous packets are assigned additional labels and then stacked while flowing through the virtual link. Therefore, as the packets are forwarded, higher labels are used. If the packets arrive at a failed opposite node, that is, the LSR B 102, the higher labels are removed from the packets, and the packets are forwarded according to lower labels. Such a conventional fast rerouting method is disadvantageous in that respective operating links must have backup tunnels established according to the links, so the configuration of the network is complicated, and resources, which must be reserved by the network, may be insufficient.

As another scheme for fast rerouting in a MPLS network using Resource ReSerVation Protocol (RSVP), there is a document which is entitled “A method for MPLS LSP fast-Reroute using RSVP Detours” by D. Gan, et al., and is available as an Internet draft “draft-gan-fast-reroute-00.txt”, Apr. 10, 2001 (hereinafter referred to as “GAN scheme”). The GAN scheme establishes detour paths on a per-LSP basis capable of routing data around failed downstream links or failed nodes, and uses latest topology information. In this scheme, fast rerouting is implemented through a method of establishing backup LSP tunnels in large scale networks. For this establishment, two additional objects are proposed in the RSVP. Further, detour paths are established so as to route data around the downstream links and nodes using the objects. If a failure occurs on a link or node of a network, user traffics are detoured through a detour path which is previously calculated and established. The GAN scheme can automatically establish a detour path on the RSVP when LSP is established. The detour path is calculated and established in a distribution fashion. Further, in order to protect the LSP from downstream link or node failure, the detour path is established between a current node and one of the downstream nodes.

FIG. 2 illustrates an example to which the GAN scheme is applied. As shown in FIG. 2, a main LSP 200 can be protected through four detour paths 210, 220, 230 and 240. Such detour paths are established such that they can be protected from any link or node failure on a working path. For example, if a failure occurs in a node B 202, data flow through the first detour path 210. That is, the first detour path 210 is established to protect the LSP 200 against link failures between a node A 201 and the node B 202 and between the node B 202 and a node C 203, and a node failure of the node B 202. Further, the first detour path 210 is calculated and initialized at the node A 201, and is merged at the node C 203. At this time, the node B 202 and a node D 204 are not aware of the first detour path 210. In a similar manner, the second detour path 220 is established to protect the LSP 200 against link failures between the node C 203 and the node D 204 and between the node D 204 and a node E 205, and a node failure of the node D 204. Further, the second detour path 220 is calculated and initialized at the node C 203, and is merged at the node E 205. The third detour path 230 is established to protect the LSP 200 against link failures between the node B 202 and the node C 203 and between the node C 203 and the node D 204, and a node failure of the node C 203. Further, the third detour path 230 is calculated and initialized at the node B 202, and is merged at the node D 204. The fourth detour path 240 is established to protect the LSP 200 against a link failure between the node D 204 and the node E 205.

In order to calculate a detour path in the GAN scheme, the Label Switched Router (LSR) can determine downstream nodes which the main LSP goes through, an outgoing link which is used on the LSR by the main LSP, and a downstream node which is to be protected, using route information recorded by reservation of RSVP. Further, when a traffic management path for the detour path is set up, the LSR may hold a new fast-route object and perform signaling. The LSR determines a destination for the detour path using the route, node, link, and signaling information.

The GAN scheme is characterized in that the detour path is dynamically established without the intervention of an operator. However, it is disadvantageous in that there is no mention on the label allocation of a detour LSP, it is suitable only for a unidirectional LSP, and a band allocated to the detour path cannot be reused while a failure does not occur.

The conventional rerouting method described with reference to FIGS. 1 and 2 is used in electrical networks. If the above rerouting method is applied to an optical transport network, many problems, such as differences between granularities of user traffics, difficulty in performing label stacking for hierarchically processing labels, and lengthening of restoration time, may occur.

### SUMMARY OF THE INVENTION

The present invention provides a fast rerouting method through Generalized Multi-protocol Label Switching (GMPLS), which performs line restoration, which is difficult to implement in a conventional Multi-Protocol Label Switching (MPLS) network, by locally repairing a failed link or path using GMPLS signaling information, routing information, and link management protocol information.

The present invention provides a method for performing fast rerouting through Generalized Multi-Protocol Label Switching (GMPLS) when a failure occurs on a link and node in an optical network having a plurality of nodes, comprising the steps of a) an ingress node of the optical network generating a path message for label request, each of nodes of the optical network (hereinafter referred to as a “current node”) lower than the ingress node receiving the path message from a higher node thereof and calculating a path therefrom to a next node thereof using information on a main Label Switching Path (LSP), included in the path message, to establish the main LSP, and the current node calculating a detour path therefrom to a next but one node thereof so as to provide against a failure of the next node; b) the current node checking whether Loss Of Light (LOS) occurs in the current node, if the current node receives a LOL message, and the current node generating a message to check whether the LOL occurs in a higher node thereof and sending the message to the higher node, if the LOL does not occur in the current node; and c) the current node establishing the detour path to allow data to flow through the detour path calculated at step a), if it is checked that the LOL occurs in the current node at step b).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing an example of a conventional rerouting method;

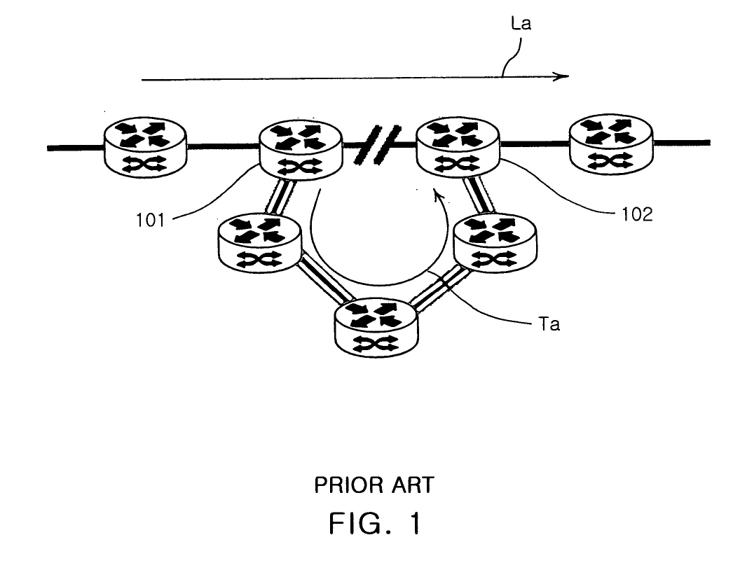

FIG. 2 is a view showing another example of a conventional rerouting method;

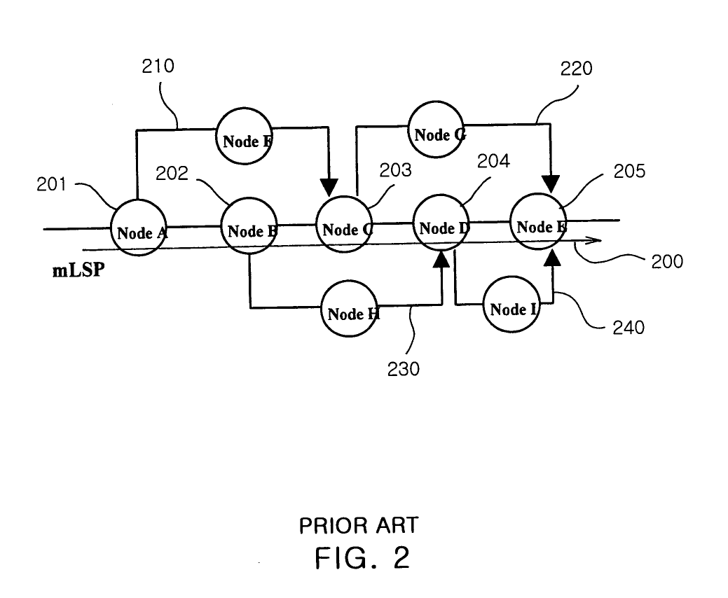

FIG. 3 is a block diagram of an Optical Cross Connect (OXC) system, which is a node of an optical transport network to which the present invention is applied;

FIG. 4 is a flowchart showing a process of establishing a main working path including a fast rerouting path according to the present invention;

FIG. 5 is a view showing an example of an optical communication network in which the main working path is established according to the present invention;

FIG. 6 is a flowchart showing a failure sensing and failure localizing process according to the present invention; and

FIG. 7 is a flowchart showing a process of establishing a detour path according to the present invention.

### DESCRIPTION OF THE PREFERRED EMBODIMENTS

Hereinafter, embodiments of the present invention will be described in detail with reference to the attached drawings.

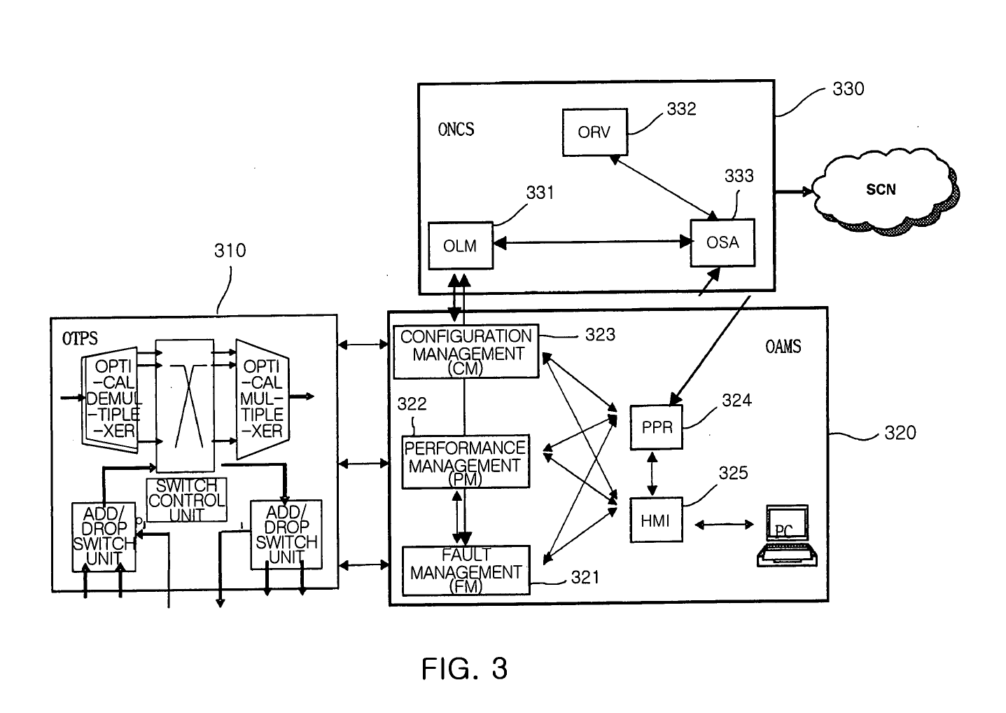

FIG. 3 is a block diagram of an Optical Cross Connect (OXC) system, which is a node of an optical transport network to which the present invention is applied. The OXC system comprises an Optical Transport Plane Sub-system (OTPS) 310, an Operation, Maintenance, Administration and Provisioning (OAM &P) Sub-system (OAMS) 320, and an Optical network Control Sub-system (ONCS) 330. The OTPS 310 includes a physical optical switch, wavelength (Lambda) converters and Add/Drop switch units.

The OAMS 320 serves to control main functions of the OXC system, and includes a microprocessor, peripheral circuits and software. The OAMS 320 processes overheads according to hierarchies, monitors operating states of functions in real time, displays the monitored results on an operator terminal, and takes action according to the occurrence of failures. The OAMS 320 performs the functions of fault management 321, performance management 322, configuration management 323, and provisioning, Protection and Restoration (PPR) 324 of the OXC system. Especially, the configuration management function 323 interfaces with a Link Management Protocol (LMP) function of the optical network control sub-system (ONCS) 330 to provide various pieces of configuration information for a client signal of the ONCS 330. The PPR function 324 interfaces with an Optical network Signaling Application (OSA) function 333 of the ONCS 330 to allow related protocols to be performed through the OSA function 333 so as to execute an optical path setup instruction and allow the performed results to be received through the OSA function 333.

The ONCS 330 provides a User Network Interface/Network Network Interface (UNI/NNI) signaling function for optical path setup in the optical network and control protocols relating to the function, and allows the optical switch to be actually controlled through information exchange with the OAMS 320. The ONCS 330 performs an Optical Link Management (OLM) function 331, an Optical Resource Reservation protocol processing (ORV) function 332, and the Optical network Signaling Application (OSA) function 333. The OLM 331 provides a Link Management Protocol (LMP) function for UNI-C (UNI client) between a client and the OXC system and UNI-N (UNI network). The ORV 332 provides an extension function of the RSVP. Further, the OSA 333 provides a signaling application function for the UNI-C (UNI client) and UNI-N (UNI network).

Hereinafter, a fast rerouting method through GMPLS according to the present invention is described in detail according to respective processes.

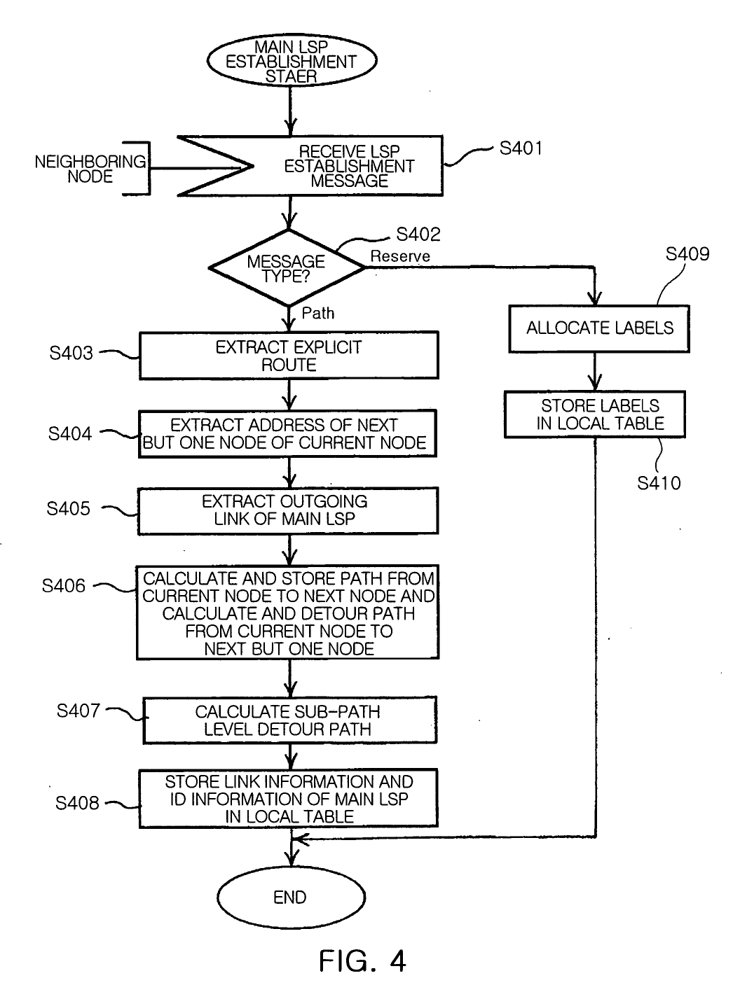

First, a main LSP establishing process is depicted in FIG. 4. FIG. 4 is a flowchart showing a process of establishing a main working path including a fast rerouting path according to the present invention. Referring to FIG. 4, in order to establish the main working path, an ingress node generates a path establishment message for label request so as to establish a main LSP which is the main working path. The ingress node sends the path establishment message to lower nodes. The path establishment message is sent to intermediate nodes. A node (hereinafter referred to as a “current node”), receiving the path establishment message from a neighboring node at step S401, first checks a message type at step S402. If it is checked that the message type is the path establishment message, the current node extracts an explicit route for the main LSP, included in the path establishment message, from the path establishment message at step S403. The explicit route is calculated at the ingress node, and then included in the path establishment message. Further, the explicit route may be information used to calculate a detour path by the current node.

Thereafter, the current node must establish a detour path on which its next but one node is a destination node by considering a case where its next node fails. Therefore, the current node extracts an address of its next but one node (hereinafter referred to as a “destination node”) at step S404. At this time, the shortest path from the current node to the destination node must be extracted as the detour path. In this case, the shortest path to the destination node must satisfy resources required by the main LSP, and must be a path to a link excepting an outgoing link of the main LSP, so the current node extracts the outgoing link of the main LSP at step S405. Thereafter, the current node calculates and stores a path from the current node to the next node using the address of the destination node and the outgoing link of the main LSP, which are extracted at the above steps, and calculates a detour path on which the next but one node of the current node is a destination node so as to provide against the failure of the next node, as described above, at step at S406. If the network is not a full mesh network, there may not be a detour path to the destination node from the current node. Therefore, the current node calculates a sub-path level detour path on which a next node of the destination node is a new destination node at step S407. Thereafter, the current node stores various pieces of information calculated at the above steps and identifier (id) information of the main LSP in a local table at step S408.

On the other hand, if it is checked by the current node that a message type is a reservation message at step S402, the current node allocates corresponding labels to links and ports of the main LSP at step S409. The labels are stored in the local table to allow a detour path to be established later at step S410.

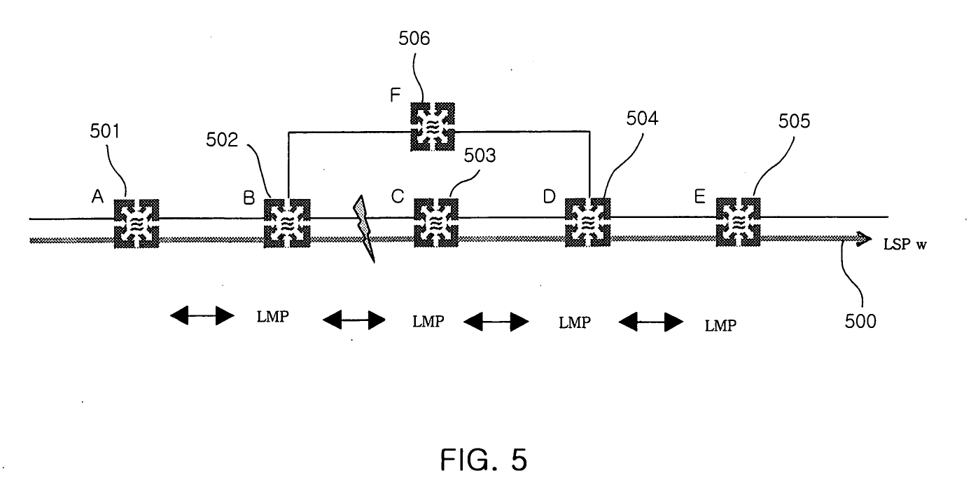

FIG. 5 is a view showing an example of an optical communication network in which the main working path is established according to the present invention. A process of establishing the main working path is described again with reference to FIG. 5. First, in order to establish the main working path, a node A 501, which is an ingress node, generates a path establishment message for label request so as to establish the main working path, that is, LSP w 500. The node A 501 sends the path establishment message to lower nodes. The path establishment message is sent to intermediate nodes. If a node B 502 receives the path establishment message, the node B 502 first checks that a message type of the received message is the path establishment message, and then extracts an explicit route for the main LSP, included in the path establishment message, from the path establishment message. The node B 502 must establish a detour path on which a next node D 504 of a node C 503 is a destination node to provide against a case where a next node of the node B 502, that is, the node C 503, fails. Therefore, the node B 502 extracts an address of the node D 504 using the extracted explicit route.

Thereafter, the node B 502 extracts an outgoing link of the main LSP, that is, LSP w 500. Further, the node B 502 calculates and stores a path from the node B 502 to the next node C 503 using the extracted address of the node D 504 and the extracted outgoing link of the main LSP. Further, the node B 502 calculates a detour path on which the node D 504 is a destination node so as to provide against the failure of the node C 503. In this case, the detour path from the node B 502 to the node D 504 is set to a path going through the node B 502, a node F 506 and the node D 504 in order. After that, the node B 502 stores information on the detour path in the local table together with the identifier information of the main LSP.

Next, a failure sensing and failure localizing process is described in detail. If most switches of an optical network are optical switches, it is very important to automatically sense Loss Of Light (LOL) and exactly recognize a position where the LOL occurs so as to rapidly process a failure. That is, in a network comprised of electrical switches and links, a link failure between two nodes can be easily sensed. However, in the OXC network, a position where a failure occurs cannot be exactly recognized. For example, if a failure occurs between the node B 502 and the node C 503 in FIG. 5, downstream nodes, not neighboring nodes between which the failure occurs, (the node C 503, the node D 504 and the node E 505 in case of a unidirectional path from the node A to the node E), determine that the failure occurs on links connected to the nodes C, D and E through loss of light. In this case, the Link Management Protocol (LMP) provides a failure management procedure including failure localization to recognize a data link and detect the position where the failure occurs. For example, if a failure occurs on a link between the node B 502 and the node C 503 of FIG. 5, an incoming port of the node E 505 determines that the failure occurs on a link connected to the node E 505 by recognizing loss of light through a power monitoring system, and informs the node D 504, which is a higher node, of the loss of light. In a similar manner, the node D 504, which is a higher node of the node E 505, also senses loss of light through its incoming ports and informs the node C 503 of the loss of light. The node C 503 also informs the node B 502 of the loss of light. Consequently, since the node B 502 receives normal light without loss through its incoming ports, it can be determined that the failure occurs at a position between the node B 502 and the node C 503.

As described above, sensing of link failure is performed by the Link Management Protocol (IMP) in the rerouting method through GMPLS according to the present invention. If the link failure is sensed by a control plane, there is no method capable of sensing an established LSP. Further, even in the case where a block controlling a configuration and status of a system receives information obtained by sensing failures of links connected to a node of the block by a physical layer (for example, a power monitoring device) of an incoming port, there is no method of actually localizing the failures. That is, it is difficult to sense whether a failure occurs on a link relating to the node of the block, or whether the failure occurs on a previous node and is propagated. Therefore, there is a problem in that failure information is provided to a signaling block, so the IMP preferably provides such a failure sensing function.

The process of sensing and propagating a failure is described again with reference to an example. If a failure occurs on a link between the node B 502 and the node D 504, or a node therebetween, the node D 504 and the node E 505 sense loss of light (LOL) of the main LSP, that is, the LSP w 500. Therefore, the node E 505 informs the node D 504 of the failure, and the node D 504 informs the node C 503 of the failure, as described above. The node C 503 informs the node B 502 of the failure of the data link LSP w 500 through a control channel. In the present invention, a failure of the node C 503 itself is limited in its failure range to a switch failure. Such a switch failure can be considered as a failure on data links through which data traffics flow. The control channel is formed through the Ethernet and is not the same as a data channel, so it must be considered to separate from the data channel. A ChannelStatus message, informing a higher node of a failure by a lower node, contains an LSP identifier (id) of the main LSP, that is, the LSP w 500, and an outgoing label for the LSP w 500. That is, the node B 502 receives the LSP id and the label from the node C 503 and the node D 504 through the control channel, so it can extract a detour path of a LSP in which the failure occurs using the LSP id.

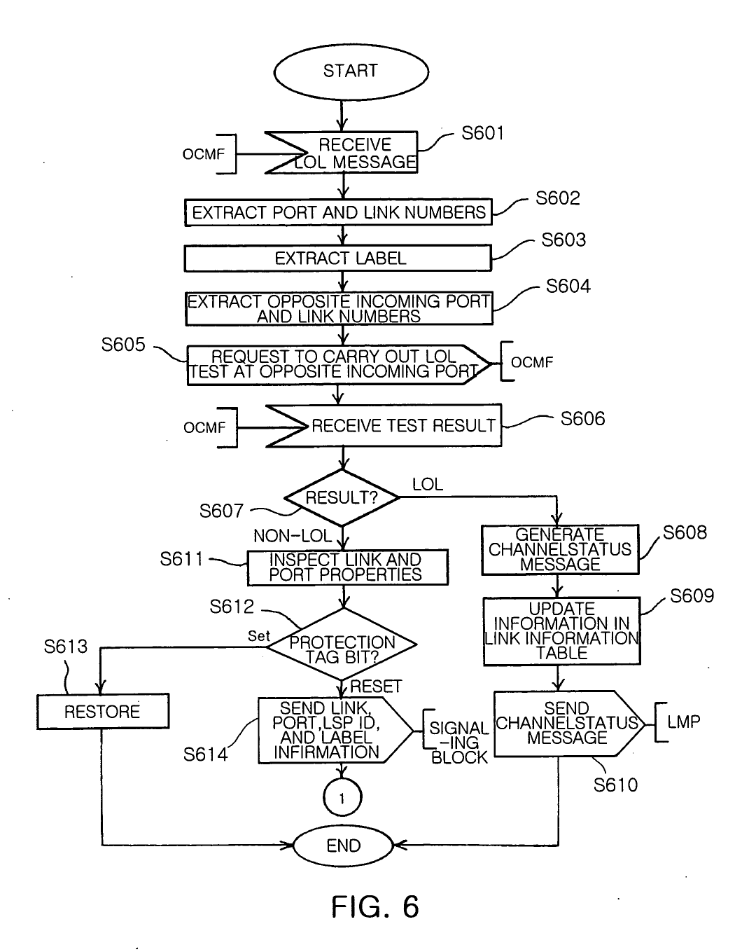

FIG. 6 is a flowchart showing a failure sensing and failure localizing process according to the present invention. First, if a certain node receives a loss of light (LOL) message as a O-channel level failure message from an Optical network Control Sub-system (ONCS) that controls the configuration of the OXC system at step S601, the node extracts port and link numbers with reference to a link information table managed by the Link Management Protocol (LMP) at step S602. The port and link numbers are basic information of routing flooding, and are information for path connection. Further, the port and link numbers can be mapped to actual label information. Thereafter, the node extracts label information for the purpose of later failure localization at step S603. The LOL message received from a downstream node has an incoming port number and a link number opposite to the extracted port and link numbers, respectively, with respect to a single LSP. The opposite incoming port and link numbers are also extracted for the later failure localization at step S604. Thereafter, in order to detect a position where light is actually lost to implement the failure localization, that is, in order to determine whether or not the position where light is actually lost is the current node, the node requests the ONCS to carry out a test for ascertaining whether the loss of light (LOL) occurs at the opposite incoming port at step S605. The node receives a test result from the ONCS at step S606, and checks the received test result at step S607. If the test result indicates the LOL at step S607, a failure does not occur in the current node, so the node generates a ChannelStatus message, which is a Link Management Protocol (LMP) message informing a higher node of the failure, so as to ascertain whether the LOL occurs in the higher node at step S608. Further, the node updates information for the node in the link information table at step S609, and sends the generated ChannelStatus message to the higher node at step S610. On the other hand, if the test result received from the ONCS does not indicate the LOL, the node inspects link and port properties, which are pieces of property information of a link and provided at the time of routing flooding at step S611. As the result of the inspection, if a protection tag bit is set at step S612, the node allows a corresponding link to directly switch over to another link at step S613. Further, if the protection tag bit is reset, this case represents a condition requiring the management of the path through the signaling block, so the node sends link, port and label information to the signaling block at step S614.

Finally, a process of establishing a detour path in a node where a failure is localized is described in detail. If a failure occurs between the node B 502 and the node C 503 in FIG. 5, the node B 502 receives a ChannelStatus message indicating a failure from the node C 503 and the node D 504 through the failure localization, as described in the failure sensing and localizing process. The ChannelStatus message includes the LSP identifier (id) of the main LSP, that is, the LSP w 500, and the outgoing label for the LSP w 500. In the detour path establishing process, the node B establishes a detour path going through the node B 502, the node F 506 and the node D 504 using the LSP id and the outgoing label for the LSP w 500, which are included in the ChannelStatus message. That is, the lambdas are cross-connected. That is, in order to establish the detour path, an inbound label of the node F 507 presents an outbound label of the node B 502. Further, an outbound label of the node F 507 is presented as an inbound label of the node D 504 merged to the main LSP. Such pieces of label information are obtained with reference to result information of the above-described failure localization through the LMP.

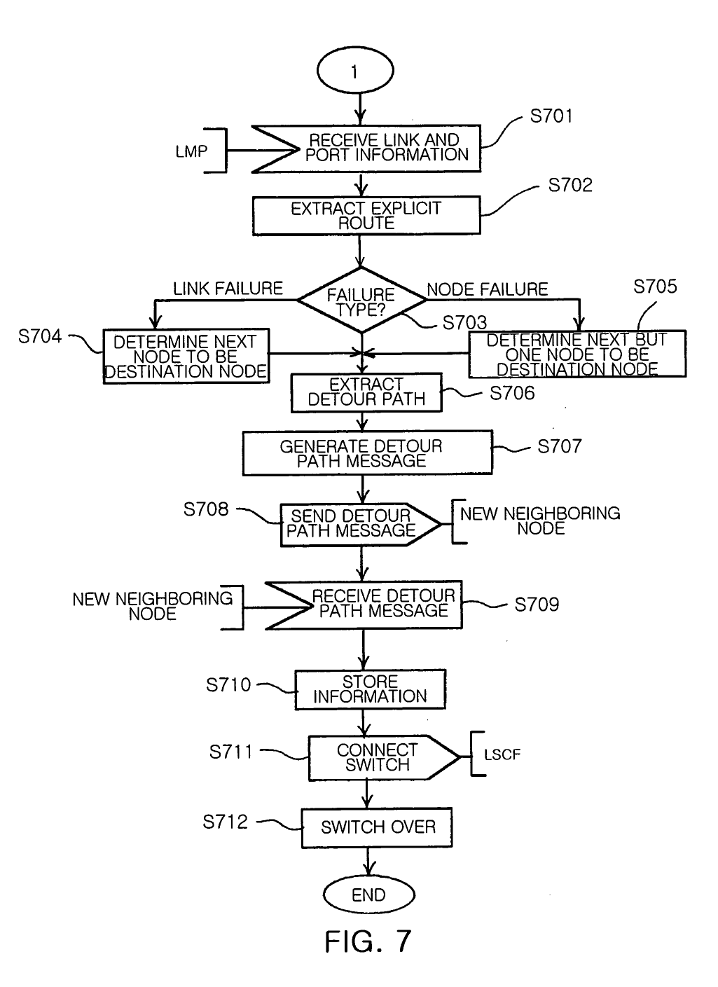

FIG. 7 is a flowchart showing the process of establishing a detour path according to the present invention. First, a current node in which a failure is localized receives link and port information of the main LSP through the Link Management Protocol (LMP) at step S701. The current node extracts an explicit route stored when the main LSP is established on the basis of LSP id information included in the link and port information, from the link and port information at step S702. Thereafter, the current node determines the type of failure at step S703. If it is determined that a failure occurs on only a link, the current node determines its next node to be a destination node of the detour path at step S704. Further, if it is determined that a failure occurs in a neighboring node of the current node, the current node determines its next but one node to be a destination node of the detour path at step S705. In the above process, if the destination node is determined, the current node extracts a detour path previously calculated for the destination node at step S706. Thereafter, in order to establish the extracted detour path, the current node must generate a detour path message at step S707. At this time, the label of a merge node of the main LSP, that is, the destination node, is previously known, so this label is generated as a suggested label. The detour path message is sent to a new neighboring node, that is, the destination node, along the established detour path at step S708. Thereafter, the new neighboring node receives the detour path message at step S709, and stores information on the detour path which will be established on the neighboring node at step S710. Further, the new neighboring node connects a switch at step S711, and allows data flow to switch over at step S712, thus completing the establishment of the detour path.

As described above, the present invention provides a fast rerouting method through GMPLS, which directly senses a failure through a layer 2, that is, a data link layer of a 7 layer model for network protocol, and performs failure localization, by which the sensed failure information is sent to an upstream node, thus entirely and rapidly performing failure restoration. Further, the present invention is advantageous in that it calculates a detour path in advance, so it can rapidly establish the detour path when a failure occurs. Further, the present invention is advantageous in that, since it does not establish a detour path in advance, it does not allocate resources in advance, thus reducing the waste of resources. Further, the present invention is advantageous in that signaling protocols of GMPLS fundamentally support both transmission and reception, so both the transmission and reception can be applied to a-failure restoration mechanism.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for performing fast rerouting through Generalized Multi-Protocol Label Switching (GMPLS) when a failure occurs on a link and node in an optical network having a plurality of nodes, comprising the step of:
a) an ingress node generating a path establishment message for label request so as to establish a main LSP which includes fast re-route path and sending the path establishment message to lower nodes;
b) a node i which receives the path establishment message from higher nodes extracting an explicit route for the main LSP, included in the path establishment message;
c) the node i extracting an address of a node j which is a next but one node of the node i, and calculating a detour path in which the node j is destination node;
d) a node n informing the higher nodes of receiving Loss Of Light (LOL) message in order, if the node n receives the LOL message, and the higher nodes ascertaining whether LOL occurs in links and their nodes; and
e) a node in which LOS occurs establishing the detour path to allow data to flow through the detour path calculated at step c), if it is ascertained that the LOL occurs in the node.

2. The fast rerouting method through GMPLS according to claim 1, wherein said detour path is the shortest path from the node i to node j.

3. The fast rerouting method through GMPLS according to claim 1, wherein said detour path is a path that satisfies resources required by said main LSP.

4. The fast rerouting method through GMPLS according to claim 2, wherein said detour path is a path that satisfies resources required by said main LSP.

5. The fast rerouting method through GMPLS according to claim 1, wherein said detour path is a path to link except a outgoing link of said main LSP.

6. The fast rerouting method through GMPLS according to claim 2, wherein said detour path is a path to link except a outgoing link of said main LSP.

7. The fast rerouting method through GMPLS according to claim 1, wherein said step c) further comprises the step of:
said node i extracting the outgoing link of said main LSP; and
said node i calculating a path to said node j using said outgoing link and the address of said node j.

8. The fast rerouting method through GMPLS according to claim 1, wherein said step c) further comprises the step of said node i storing link information to said detour path and an identifier of said main LSP.

9. The fast rerouting method through GMPLS according to claim 1, wherein said step d) further comprises the step of:
said node n recognizing said LOL message at its input terminal, and determining that the failure occurs on links connected to itself;
said node n informing the higher nodes of failure message in order;
the higher nodes which receive the failure message ascertaining whether LOL occurs by ascertaining input light at their input terminal; and
the higher nodes in which LOL does not occurs informing the failure message and the higher nodes in which LOL occurs determining that the failure occurs on link between themselves and their lower nodes.

10. The fast rerouting method through GMPLS according to claim 9, wherein said step of ascertaining whether LOL occurs comprises the steps of:
the higher nodes receiving the failure massage from lower nodes; and
the higher nodes determining that LOL occur if their input terminal receives light without loss.

11. The fast rerouting method through GMPLS according to claim 9, wherein said ascertaining whether LOL occurs is implemented by a Link Management Protocol (LMP).

12. The fast rerouting method through GMPLS according to claim 9, wherein said step of informing the higher nodes of failure message comprise the step of:
the higher node receiving LSP identifier and label through control channel from the lower node; and
the higher node informing the next higher node of the failure of data link.

13. The fast rerouting method through GMPLS according to claim 9, wherein said failure message has input terminal of appropriate node corresponding to one LSP, port number and link number.

14. The fast rerouting method through GMPLS according to claim 1, wherein said step e) further comprises the step of:
determining destination node of detour path by failure link or node;
extracting the calculated detour path to the determined destination node;
generating the detour path message;
sending the detour path message to neighboring node through the extracted detour path; and
storing the information for establishing the detour path and switching-over the data flow to another link.

15. The fast rerouting method through GMPLS according to claim 14, wherein said step of determining destination node further comprises the step of:
determining the type of failure;
determining the next node to be a destination node of the detour path, if the failure occurs on only a link;
determining the next but one node to be a destination node of the detour path, if the failure occurs in a neighboring node.

16. The fast rerouting method through GMPLS according to claim 1, wherein said step e) includes the step of establishing the detour path using LSP identifier and outgoing label to the main LSP comprised by failure message.
